(19) United States
(12) Patent Application Publication
(10) Pub. No.: US 2024/0271482 A1
(43) Pub. Date: Aug. 15, 2024

(54) DOOR

(71) Applicant: SEUSTER KG, Lüdenscheid (DE)

(72) Inventor: Jörg Fischer, Lüdenscheid (DE)

(21) Appl. No.: 18/290,696

(22) PCT Filed: Jul. 27, 2022
(86) PCT No.: PCT/EP2022/071035

§ 371 Date: Jan. 19, 2024

(30) Foreign Application Priority Data
Jul. 29, 2021 (DE) 10 2021 119 696.5

(51) Int. Cl. E06B 9/15; E06B 9/17; E06B 9/58

(52) U.S. Cl. CPC E06B 9/15; E06B 9/17; E06B 9/58; E06B 2009/1566

(57) ABSTRACT

Embodiments relate to a door, in particular a roller door, having a door leaf which is at least partially configured as a web-like curtain made of flexible material and which is movable along a movement path between an open position, in which at least partially opens a wall opening and possibly forms a multilayer winding above the wall opening, and a closed position, in which it at least partially closes the wall opening, wherein the web-like curtain is assigned a stabilizing device which extends transversely, in particular approximately perpendicularly, to the movement path and which, at least in the closed position, counteracts deformation of the curtain in a load direction extending perpendicularly to a closing plane defined by the movement path and the stabilizing device.

### CROSS REFERENCE TO RELATED APPLICATION

This present application is a 35 U.S.C. § 371 national phase entry application of, and claims priority to, International Patent Application No. PCT/EP2022/071035 filed Jul. 27, 2022, which claims priority to German Patent Application No. DE 10 2021 119 696.5 filed Jul. 29, 2021, the disclosures of which are hereby incorporated by reference in their entirety for all purposes.

### BACKGROUND

Roller doors may be used in particular to close hall entrances. The closing element designed as a door leaf can be wound up on a winding shaft arranged above the hall entrance during a transition from the closed position to the open position. This ensures space-saving storage of the door leaf in the open position. For this purpose, the door leaf can be formed in the form of so-called slat armor having a large number of slats which are connected to one another in an articulated manner with respect to joint axes extending perpendicular to the direction of movement of the closing element. In cases where it is less important to have a burglar-proof closure of the entrance than to have a quick opening and closing movement for opening and closing the entrance, the closing element can also be formed at least partially in the form of a web-like curtain, for example made of PVC, which can be formed from multiple curtain segments divided in the direction of the web and connected to one another.

The high-speed roller doors having a closing element or door leaf in the form of a web-like curtain, possibly formed from multiple connected to one another curtain segments, has to meet various, sometimes conflicting, requirements. On the one hand, the roller doors have to have a certain stability transversely to the direction of movement or transversely to the planar extension of the curtain in the closed position in order to be able to withstand external influences, such as wind loads, which can result in the curtain bulging. Furthermore, it has proven to be advantageous if the individual curtain segments forming the curtain are releasably connected to one another, because in case of damage, repair, and/or maintenance, the curtain can be easily disassembled and individual curtain segments can be replaced. Such roller doors are described, for example, in international published application WO 2018/219512A1. The individual curtain segments are releasably attached to one another via a connecting device consisting of stabilizing profiles formed as extruded aluminum profiles and beadings that engages with the extruded aluminum profiles. While the required stability, especially against wind loads, and an easy disassembly option are achieved, the extruded aluminum profiles require a reduction in the moving speed of the roller doors and an increased noise level when winding and unwinding the curtain. It has been found that the aluminum extruded profiles strike against the winding shaft when being wound onto the winding shaft and when unwinding from the winding shaft and produce an unround door run. Gates having curtain segments connected to one another via connecting devices formed from metallic profiles are also disclosed in DE 10 2019 126 898 A1 and CN2480527Y.

Legacy roller doors also exist in which the curtain segments are permanently attached to one another, in particular by welding, or the curtain is produced in one piece. With such roller doors, the required stability against external influences, such as wind loads, can be achieved by providing the curtain with stabilizers, such as flat spring steel sheets. Roller doors formed in this way are characterized by excellent running properties and speeds, without any annoying winding noises. The disadvantage of such roller doors is, among other things, that in case of damage, repair, and/or maintenance, even if the one-piece curtain is slightly damaged or if only individual curtain segments are damaged, the entire curtain usually has to be replaced, which results in a high work and cost expenditure. Disassembling or replacing individual curtain segments is not possible.

It has been found that despite the high running speeds of the roller doors, so-called collision damage is produced when a vehicle, for example a forklift, runs into the curtain during the opening movement of the curtain or also in the closed position and damages it. The curtain is usually damaged at a lower edge region in the closed position. Furthermore, running into the curtain, for example by a vehicle, can result in cracks forming in the curtain made of a flexible material and/or the guide elements used to guide the movement of the curtain being damaged.

In view of the above-described problems, it is proposed in WO 2004/088080 A1 that the stabilizing element arranged at the lower edge of the closing element in the closed position be designed to be elastically deformable so that it can convert at least part of the impact energy into deformation energy. Furthermore, in order to increase the operational reliability of the doors, at least one guide device which interacts with the guide element is arranged on at least one lateral edge of the closing element and is configured to detach from the guide element when a vehicle collides with the closing element in order to avoid damage to the curtain, the guide element, or the guide device. In order to still ensure reliable guidance of the movement of the closing element, an inlet arrangement can be arranged at the upper edge of the guide element, using which the guide element is automatically insertable into the guide element during a closing movement of the closing element. According to WO 2004/088080 A1, the inlet arrangement can be combined with a pre-tensioning device, using which the closing element or the stabilizing element is displaced in directions that are opposite to one another and extend transversely to the direction of movement of the closing element. As a result, centering of the lower edge of the closing element can be achieved in order to ensure reliable insertion of the lower edge of the closing element into the guide elements even at high closing speeds.

Both the elastically deformable stabilizing elements at the lower edge of the closing element and the inlet arrangements for the guide elements, which are provided with pre-tensioning devices, reduce the damage caused when vehicles collide with the closing elements. Nevertheless, collisions with vehicles continue to result in unacceptable damage to the closing elements and/or the guide elements, in particular when the closing elements are formed from a curtain made of an elastically flexible material. On the one hand, neither the flexibility of the stabilizing element nor the releasable connection of the closing element or guide device and guide element as well as their reliable insertion into one another is sufficient to preclude damage to the closing element and/or the guide elements. On the other hand, it has not been possible up to this point by means of the doors known in the prior art to solve the problem that if there is damage to one-piece curtains or curtains made of curtain segments that are permanently attached to one another, the entire curtain always has to be replaced.

In view of the above-described problems, embodiments relate to the object of improving a generic door, in particular of providing a door that enables high running speed and wind stability while at the same time ensuring easy repair and maintenance.

Embodiments relate to a door, in particular a roller door, having a door leaf which is at least partially configured as a web-like curtain made of flexible material and which is movable along a movement path between an open position, in which it at least partially opens a wall opening and possibly forms a multilayer winding above the wall opening, and a closed position, in which it at least partially closes the wall opening, wherein the web-like curtain is assigned a stabilizing device which extends transversely, in particular approximately perpendicularly, to the movement path and which, at least in the closed position, counteracts deformation of the curtain in a load direction extending perpendicularly to a closing plane defined by the movement path and the stabilizing device.

Accordingly, a door, in particular a roller door, movable along a movement path between an open position in which it at least partially opens a wall opening and possibly forms a multi-layer winding above the wall opening if it is designed as a roller door, and a closed position in which it at least closes the wall opening, comprises a door leaf movable along a movement path and at least partially configured as a web-like curtain made of flexible material. The movement path can be divided into a movement path section oriented essentially in the vertical direction, along which the door leaf moves when it at least partially closes the wall opening, and into a movement path section which is inclined with respect to the vertical direction and which, for example, is oriented essentially in the horizontal direction and along which those door leaf sections move that do not close part of the wall opening. Alternatively, if the door is implemented as a roller door, the door leaf can be wound into a multi-layered winding above the wall opening, so that the movement path section adjoining the vertical path section is designed in a spiral shape. The movement path of the door leaf can, for example, be predetermined via guide devices arranged on lateral edges of the door leaf, which cooperate with guide elements arranged on the wall delimiting the wall opening, such as guide rails, in order to guide the door leaf during the opening and closing movement. The curtain can also have a rigid lower part, for example made of metal, such as steel or aluminum, which in particular forms the lower edge section of the curtain in its closed position, for example if increased wind stability is required.

The web-like curtain is assigned a stabilizing device which extends transversely, in particular approximately perpendicularly, to the movement path and which, at least in the closed position, counteracts deformation of the curtain in a load direction extending perpendicularly to a closing plane defined by the movement path and the stabilizing device. Typically, the stabilizing device can be rigid and/or made of aluminum or metal. The configuration of the door leaf as at least partially made of flexible material enables the space requirement to be reduced because the material itself adapts to the winding to be formed in the open position and thus enables a small spiral diameter in the open position. At the same time, the stabilizing device implements a robust door leaf. In this context, it is possible for the door leaf to be guided along the movement path with the aid of a guide arrangement and/or joint arrangement coupled to the stabilizing device, as described in WO 2018/219512 A1, the content of which is fully incorporated herein by reference. Commercially available, preferably transparent or colored PVC and/or polycarbonate can be used as the flexible or resilient material for producing door leaves according to various embodiments. The door can be adapted to appropriate requirements or conditions via the thickness of the plastic web. The yielding or flexibility ensures a small winding radius for space-saving storage of the curtain in the closed position. Polycarbonate in particular has proven to be a material with excellent properties for use in doors according to the various embodiments. The material has high elasticity with sufficient flexural rigidity to follow the winding contour even with large widths. The material also has other positive properties such as high impact resistance.

According to the various embodiments, the web-like curtain has at least two curtain segments which follow one another in the direction of the movement path and which are releasably connected to one another along at least one intended dividing line extending in the closing plane, preferably approximately perpendicular to the movement path, in such a way that the edges of the curtain segments facing toward one another remain deformable. Releasable in the sense of the present description is to be understood as meaning that the connection of the curtain segments can be released or separated, in particular manually, without causing damage to components of the door, in particular the connected curtain segments. The intended dividing line can be an imaginary axis in the region of the fastening zone between the two curtain segments. For example, the intended dividing line can be arranged in relation to the movement path, in particular centrally, between the edges facing toward one another of the path segments to be connected. The term “intended dividing line” used in this application comprises an intended dividing region which can have an extension of the order of magnitude of a multiple of the thickness of the curtain segments both in the direction of the movement path and in a direction extending perpendicular to the closing plane.

Thus, the conflict of interest underlying the present disclosure between a high running speed and high wind stability on the one hand and a simple repair and maintenance option on the other can be resolved. Because the edges of the curtain segments facing toward one another remain deformable, there is flexibility in relation to the forces acting in case of a collision of a vehicle, which reduces the risk of damage to the curtain. The releasable connection of the curtain segments can be designed to be free of rigid fastening or connecting profiles. A crucial development concept lies in the functional separation of the stabilization of the curtain, which is provided via the stabilizing device, and the fastening of the curtain segments to one another, which is achieved by the releasable connection. If the curtain is damaged, it is no longer necessary to replace the entire curtain. The possibility is created of replacing individual curtain segments in a simple, cost-effective, and easy-to-install manner by releasing the connection between the curtain segments.

In an example embodiment, a curtain segment forming the lower edge of the curtain is connected to a curtain segment trailing in the closing movement. Furthermore, a stabilizing device can be arranged at the lower edge of the curtain segment forming the lower edge of the curtain. The stabilizing device can be designed in accordance with WO 2004/088080 A1, the content of which is incorporated herein in full by reference.

In a further example embodiment, the door comprises an at least partially deformable, in particular elastically deformable, connecting device for releasably connecting the edges facing toward one another of the curtain segments. In particular because the connecting device does not necessarily have to contribute to increasing stability, it can be made elastically deformable and flexible, in contrast to the rigid stabilizing device which is usually made of aluminum or metal. The connecting device can extend over the entire curtain width, which is oriented transversely to the movement path, and can attach the curtain segments to be connected to one another over its entire width. The elasticity of the connecting device has the advantage that the connecting device can deform back into its original shape after a deformation, which accompanies a collision with a forklift, for example, so that the curtain can, on the one hand, continue to close the wall opening cleanly and, on the other hand, is movable reliably along the movement path, in particular in the open position can also be wound up into a winding. According to an example refinement of the door according to some embodiments, the connecting device consists exclusively of an elastically deformable material, in particular an elastomeric material and/or plastic. For example, the materials polyvinyl chloride (PVC), in particular hard PVC, polyethylene (PE), ethylene propylene diene monomer (EPDM), styrene-butadiene (SBR), and silicone, are suitable. In this embodiment, the intended dividing line or the intended dividing region may be formed by the transitions between the connecting device and the edges of the curtain segments.

In a further example embodiment of the door, the connecting device is designed such that a curtain segment forming the lower edge of the curtain and a further curtain segment each can be or are releasably attached thereon. Because the connecting device is releasably connectable to both curtain segments to be connected, it is not only possible to easily replace the curtain segments in case of damage and/or maintenance, but also to replace the connecting device itself with little installation effort if it needs to be replaced. The releasable fastening can be implemented by a form fit, which is characterized in particular in that easy assembly and disassembly of the curtain segments or the connecting device is ensured.

According to a further example embodiment of doors, the connecting device has two receptacles, each assigned to one of the curtain segments to be connected, for formfitting accommodation of one of the edges facing toward one another of the curtain segments. For example, the connecting device has a receptacle assigned to an upper edge of the curtain segment forming the lower edge of the curtain and a receptacle assigned to the lower edge of the curtain segment trailing in the closing movement direction. The edges can have thickenings, for example in the form of a bead or a keder. The formfitting engagement between the edge and the receptacle can be implemented, for example, in the manner of a keder rail.

According to an example refinement, the receptacles are made in one piece with one another. For example, the receptacles, in particular the connecting device, can be produced in a plastic injection molding method, a plastic extrusion method, or a foaming method. This means that cost-effective manufacturing methods that are suitable for mass production can be used. The receptacles can each have a guide groove extending in the longitudinal direction of the receptacles, which in the assembled state on the curtain is oriented transversely to the movement path of the door leaf, in particular with a constant cross section in the direction of the intended dividing line, for inserting the edges of the curtain segments. The edges are inserted in the longitudinal direction of the guide grooves. Furthermore, the receptacles can each have a longitudinal opening oriented in the direction of the movement path of the door leaf for sections of the curtain segments adjoining the edges or for connecting means coupled to the curtain segments. This means that the edges are either produced or formed in one piece with the respective curtain segments or are part of separate connecting means, which are in particular coupled by material bonding to the curtain segments. Furthermore, the longitudinal openings can have a clear width in the load direction that is smaller than the maximum dimensions of the thickenings accommodated in the receptacles in this direction. The design of the receptacle having guide groove and longitudinal opening enables simple assembly for formfitting coupling of the connecting device to the curtain segments as well as simple disassembly. This means that even untrained operating personnel can replace a damaged curtain segment and/or the connecting device in case of damage and/or maintenance. On the other hand, the formfitting coordination of the guide groove and edge provides a predefined assembly and disassembly direction, so that easy assembly and disassembly is guaranteed and incorrect assembly can be avoided. In addition, the edges are guided in the longitudinal direction into the guide grooves in the receptacle during insertion. Because of the formfitting interlocking, the connecting device can be easily pulled or pushed onto the curtain segments without tilting or jamming.

In a further example embodiment of the door, the connecting device is designed such that when a load acting on the curtain exceeds a predetermined load limit in the load direction, at least one of the, in particular both, curtain segments is released using the deformability of the connecting device, for example by widening the longitudinal opening. This design of the door leaf is based on the knowledge that collision damage or impacts with forklifts, for example, often result in damage to the curtain in the region of the fastening interface between the curtain segment and the connecting device. This design of the door leaf is particularly noticeable when high loads are applied, for example at high speeds of the object causing the collision, such as the forklift. Because the connecting device releases at least one of the curtain segments as soon as the applied load exceeds a predetermined load limit, the connecting device is equipped with a damage protector. In other words, the fastening interface between curtain segment and connecting device forms an intended dividing line or an intended dividing region, so that if the applied load is too high, the fastening, in particular the formfitting engagement, between curtain segment and connecting device is released. As a result, damage protection is achieved while accepting at least partial, in particular automatic, disassembly of the door leaf. The edges of the curtain segments can be matched in shape to a dimension of the longitudinal openings of the receptacles of the connecting devices so that when the predetermined load limit is exceeded, the edges are at least partially pressed through the longitudinal openings and can move out of the guide grooves using the elastic flexibility of the connecting device and/or the edges themselves. For example, the load limit is approximately 20 kilograms per meter (kg/m). The releasable connection between the curtain segments, in particular the connecting device, may be designed in such a way that, in case of a load, damage to the curtain segment trailing in the closing movement direction is avoided. Under certain circumstances, this can be done while accepting damage to the curtain segment leading in the closing movement direction, in particular forming the lower edge of the curtain.

In a further example embodiment of doors, the cross section of the connecting device is designed to be symmetrical in a plane of section extending perpendicular to the longitudinal direction with respect to an axis oriented in the direction of movement, in particular a vertical central axis, and/or with respect to an axis oriented parallel to the intended dividing line, in particular horizontal central axis. Due to the double axis symmetry, the connecting device has a geometry that is easy to produce. Furthermore, assembly is facilitated because the orientation of the connecting device in relation to the curtain is not important. For example, the connecting device can have a double C shape in cross section. Furthermore, the connecting device can have a connecting web connecting the receptacles, which is in particular produced in one piece with the receptacles, through which the horizontal axis of symmetry extends.

According to an example refinement, the connecting device is arranged in the closed position at a distance in the range of 250 millimeters (mm) to 1,250 mm from the floor. Because the curtain is usually damaged at a lower edge region in the closed position, it is advantageous to arrange the connecting device at a vertical height in such a way that such collision damage is largely made possible by simply replacing the lower curtain segment, possibly including the connecting device. For example, the connecting device is located at a distance in the range of 350 mm to 1,000 mm or up to 500 mm from the ground.

In a further example embodiment, the connecting device is designed as a double keder rail. It was found that the connection of two curtain segments can also be implemented satisfactorily via this fastening technology.

According to a further example embodiment, two additional curtain segments that follow one another in the direction of the movement path are permanently connected to one another, in particular adhesively bonded and/or welded. The door leaf can be designed in such a way that, with the exception of the curtain segment forming the lower edge of the curtain, all curtain segments are permanently connected to one another. This means that the rigid extruded aluminum profiles used in the prior art to connect curtain segments, which had a negative effect on the running speeds of the doors, can be dispensed with. Furthermore, the production of door leaves of doors is also facilitated.

According to an example refinement, the curtain segments are connected to one another in such a way that they can only be released from one another when a safeguard has been released. In this context, what is meant is the releasability of the curtain segments in the direction of the intended dividing line or the intended dividing region. The deformability of the curtain segments and their releasability from one another in the load direction can still be maintained. For example, the connecting device can be assigned a securing device for preventing a relative movement of the curtain segments in the direction of the intended dividing line or for preventing the curtain segments from moving away from one another in the direction of the intended dividing line. In this case, a securing device, such as an end or securing cap, can be arranged on at least one lateral end of the connecting device, in particular on both lateral ends of the connecting device, which is releasably connected to the connecting device and/or one of the curtain segments, in particular screwed, latched, or clamped. The securing device can, for example, be shaped and/or dimensioned in such a way that it overlaps the securing device in the direction of the movement path on at least one side and can optionally be applied to a lateral edge of the curtain.

In a further example refinement of the door, the securing device is connected to the connecting device in a formfitting manner. The formfitting connection can be such that the securing device overlaps the connecting device in the load direction. For example, the securing device has a receptacle recess which is shaped to match with respect to the connecting device and in which a lateral end of the connecting device can be accommodated, in particular in a clamping manner. The securing device can be designed to have a stability-increasing effect in the lateral edge region of the connecting device. For example, the securing device in the lateral edge region of the connecting device can counteract a deformation of the securing device in the load direction. In this respect, the securing device can take on a dual function, namely avoiding a relative movement of the curtain segments in the direction of the intended dividing line and reducing or avoiding deformation of a lateral edge region of the securing device in the load direction.

According to an example refinement, the connecting device is provided with at least one, in particular with at least two, three, or four, fastening holes for receiving fastening means, such as screws, clips, or the like, for fastening the securing device and the connecting device to one another. Furthermore, it is possible for the securing device to be free of direct attachment to the curtain segments, but rather to be coupled to the curtain segments exclusively indirectly via the connecting device. This can be advantageous, for example, because in case of severe overloading, complete separation of the curtain segments from one another can be ensured in order to avoid possible damage to the curtain segments.

In some embodiments, curtain segments made of different materials are connected to one another using the connecting device. For example, a curtain segment made of a transparent material can be connected to an opaque curtain segment, for example made of a fabric-like material. The curtain segments made of different materials usually have different coefficients of expansion. For example, a curtain segment made of transparent material can be subject to a shrinking process. In order to avoid defects in the region of a transition between the individual curtain segments, it has proven to be expedient, in particular when connecting curtain segments made of different materials, if at least one fixing device designed to fix at least one edge of at least one curtain segment extending perpendicular to the movement path with respect to at least one connecting device is provided.

The fixing device can have at least one fixing bolt, such as a fixing screw, which passes through an edge to be fixed and extends in particular transversely, preferably approximately perpendicularly to the closing plane. In other embodiments, a fixing bolt can extend approximately parallel to the edge of a curtain segment to be fixed and can be accommodated in the receptacle of a connecting device that receives this edge, wherein the fixing bolt in this embodiment pushes the edge to be fixed against a boundary surface of the receptacle. However, in terms of reliable fixing, it has proven to be particularly useful if the fixing bolt extends perpendicular to the edge to be fixed and passes through this edge, in particular if it is screwed into this edge.

In an example embodiment, the restoring force counteracting a deformation of the connecting device in the load direction is less than the restoring force counteracting a deformation of the stabilizing device in a direction extending perpendicular to the load direction. As a rule, the load direction points into the space to be closed by the door leaf or in the opposite direction. As a result, the consequences of damage resulting from a collision, for example with a forklift, can be further reduced, since the curtain is able to convert a larger proportion of the kinetic energy into deformation energy without damage occurring, such as cracks, in particular at the connection points between curtain and connecting device.

According to a further example embodiment, the door may have at least one guide device arranged on a lateral edge of the door leaf, by means of which the door leaf is guided during a movement in the closing plane. Furthermore, the door can have an inlet arrangement arranged at the upper edge of the guide device, using which the lateral edge of the door leaf is automatically insertable into the guide device during a closing movement. With regard to the inlet arrangement, reference is made to WO 2004/088080 A1, the content of which is incorporated herein by reference. In particular, the inlet arrangement at the upper edge of the guide device has at least two pre-tensioning devices which can be applied to opposing boundary surfaces of the door leaf and/or a stabilizing element arranged at the lower edge thereof, using which the door leaf or the stabilizing device is pushed in directions extending opposite to one another and transverse to the movement path of the door leaf.

In a further example embodiment, the curtain segment leading along the movement path during a closing movement, in particular forming the lower edge of the curtain, has an optical indicator which is visually different from the adjacent curtain segment. This can attract increased attention, for example, among people who wish to pass through the door with vehicles such as forklifts. Furthermore, increased visibility is achieved, in particular in the dark, so that possible damage can be avoided. For example, the optical indicator can be a color or paint of the curtain segment, an imprint, or an indication means applied to the curtain segment in some other way, for example adhesively bonded. The optical indicator can have an increased degree of reflectance in comparison to the adjacent curtain segment. Furthermore, the optical indicator can be designed as, for example, a yellow or red warning bar in order to also provide an additional visual indication of a possible danger point.

In embodiments, at least one connecting device can be provided with a securing device designed to absorb axial forces acting parallel to the edges of the curtain segments that extend perpendicular to the movement path. Using such a securing device it is possible to prevent the edges of the door leaf that extend parallel to the movement path from being offset in a direction extending perpendicular to the movement path, because the corresponding axial forces are absorbed by the securing device.

A securing device designed to absorb axial forces can have securing means that are fixedly attached with respect to the wall opening and at least one securing module attached to the door leaf, in particular the connecting device, having at least one contact surface that can be applied to a counter surface of the securing means to absorb axial forces. When axial forces acting perpendicular to the movement path occur on an edge of the door leaf extending parallel to the movement path, the contact surface of the securing module is applied to the counter surface of the securing means. In this way, an offset of the lateral edge of the door leaf extending parallel to the movement path is inhibited in a direction extending perpendicular to the movement path.

In embodiments, the contact surface of the securing module can be formed by at least one guide roller, which is rotatably mounted, in particular with respect to a roller axis extending perpendicular to the closing plane in the closed position, which may be accommodated in the closed position in a securing means, extending approximately in the direction of gravity and passes through a slot through which a lateral edge of the door leaf reaches and designed as a hollow profile. In this embodiment, the securing device not only acts to absorb axial forces, but also as a guide means to guide the movement of the door leaf. The securing module can have two guide rollers arranged on opposite sides of the door leaf or the connecting device and rotatably mounted with respect to coaxially extending roller axes, which can be applied to corresponding counter surfaces of the securing means designed as a hollow profile. In embodiments, corresponding securing means and securing modules can be provided on opposite edges of the door leaf that extend parallel to the movement path. The securing modules can be attached to opposite axial ends of at least one connecting device, in particular fastened in a formfitting, friction-locked, and/or materially-bonded manner.

Within the scope of this discussion, the connecting device is designed to be at least partially deformable, in particular elastically deformable, to ensure the deformability of the edges facing toward one another of the web segments. In the case of a deformable connecting device provided within the scope of the present disclosure, the desired axial force securing can be achieved without impairing the deformability of the connecting device if the securing device has a tension safeguard interconnecting the securing modules attached to opposite axial ends of the connecting device, which can be designed, for example, in the form of a strand body, in particular a cable, such as a wire cable, and which is able to transmit tensile and/or compressive forces without significantly impairing the deformability of the edges of the door leaf extending perpendicular to the movement path. The tension safeguard, such as a wire cable or the like, can pass through a channel in the connecting device extending parallel to the edges of the curtain segments.

In embodiments having a security device having securing modules, it has proven to be expedient if at least one fixing bolt, such as at least one fixing screw, passes through at least one securing module. In the closed position of the door leaf, the fixing bolt can extend perpendicular to the closing plane of the door leaf and pass through both the securing module and the edge of a curtain segment extending transversely to the movement path. This edge of the curtain segment can protrude in the axial direction beyond the connecting device and can be accommodated in the securing module.

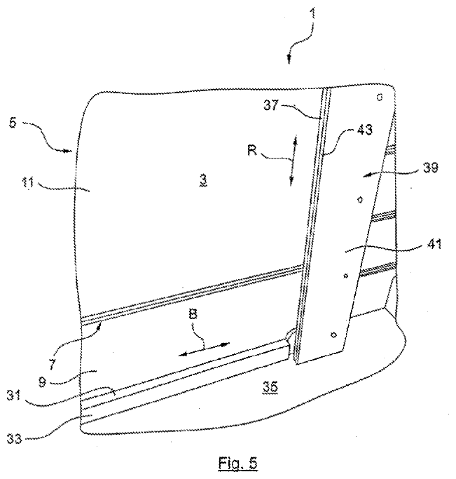

In the following description of example embodiments, a door according is generally provided with the reference number 1. In the accompanying figures, the door 1 is designed, for example, as a roller door, the door leaf 5 of which is designed in the form of a web-like curtain 3 and can be moved along a predetermined movement path R between a closed position shown in FIG. 5, in which it closes a wall opening, and an open position in which the door leaf 5 can be wound or is wound into a multi-layer winding.

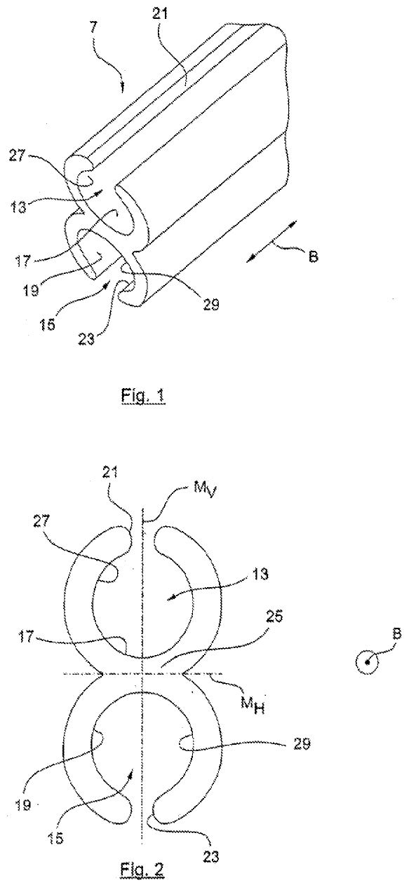

Referring to FIGS. 1 and 2, an example embodiment of a connecting device 7 for releasably fastening together the curtain segment 9 forming the lower edge of the curtain 3 with an adjacent curtain segment 11, which trails the lower curtain segment 9 during a closing movement, is described. The connecting device 7 is implemented in FIGS. 1 to 3 as a double keder rail, which is produced from of an elastically deformable or flexible material and in one piece. The connecting device 7 has two identically formed receptacles 13, 15, each assigned to one of the curtain segments 9, 11, each of which is equipped with a guide groove 17, 19 and a longitudinal opening 21, 23 extending in the longitudinal direction of the connecting device 7. When viewed together with FIG. 5 it can be seen that the longitudinal extension direction of the connecting device 7 in the assembled state on the curtain 3 is oriented transversely, in particular perpendicularly, to the movement path R of the door leaf 5 during an opening and closing movement. The longitudinal direction of the connecting device 7 in the assembled state, which also defines the intended dividing line, is also referred to below as the width direction B.

In the sectional view of the connecting device 7 shown in FIG. 2, it can be seen that the connecting device 7 has a constant cross section along its entire longitudinal extension in the longitudinal direction or width direction B. Furthermore, the example embodiment of the connecting direction 7 according to FIGS. 1 to 3 is designed to be double axis symmetrical in cross section. As can be seen in FIG. 2, the connecting device 7 is designed to be axially symmetrical with respect to a vertical central axis M_{V} oriented in the direction of the web direction R. In addition, the connecting device 7 is designed to be axially symmetrical with respect to a horizontal central axis M_{H} which extends through a connecting web 25 connecting the two C-shaped receptacles 13, 15 and is oriented parallel to the intended dividing line.

One advantage of the door 1 lies, among other things, in the elasticity of the connecting device 7 and in the formfitting connection option provided thereby between the lowest curtain segment 9 and the curtain segment 11 arranged above it in the closed position. The individual curtain segments 11, 9 are assembled with the connecting device 7 in each case according to the following principle: The connecting device 7, in particular its receptacles 13, 15, is designed to be open on both end sides, on which insertion openings 27, 29 are present, via which edges of the curtain segments 9, 11, which extend transversely to the direction of movement R and are usually equipped with thickenings such as beads or keder, are insertable laterally into the receptacles 13, 15 and along the guide grooves 17, 19. Via the longitudinal openings 21, 23, which are narrower in cross section and oriented in the direction of movement R in the assembly position, sections of the curtain segments 9, 11 adjoining the edges or connecting means coupled to the curtain segments 9, 11, such as keder tabs, which are dimensioned narrower in cross section than the thickenings, can be led out of the receptacle 13, 15. This creates a formfitting engagement which is easy to assemble and disassemble between the curtain segments 9, 11 and the connecting device 7.

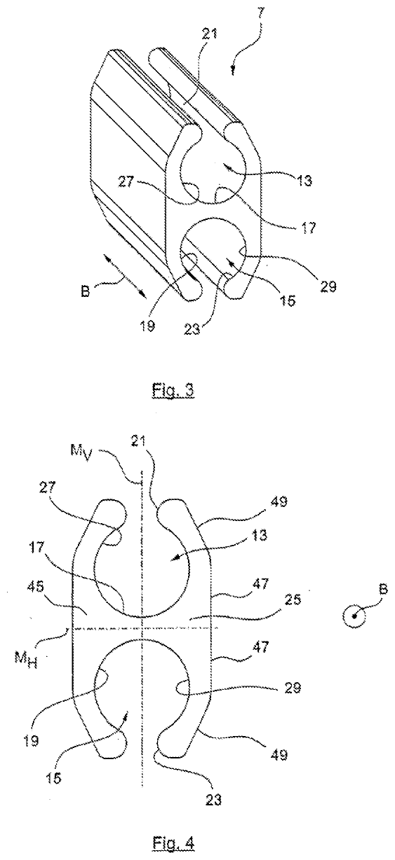

The connecting device 7 of FIGS. 3 and 4 is similar in its functionality and basic structure to the connecting device 7 of FIGS. 1 and 2. In contrast to the embodiment of FIGS. 1 and 2, the connecting device 7 of FIGS. 3 and 4 has a higher stability, in particular in the load direction. The stabilizing device 7 is reinforced in the region of the connecting web 25 and has a central reinforcement region 45 into which the two receptacles 13, 15 open. Another difference is that the outer contour of the receptacles 13, 15 is not circular in shape according to the embodiment according to FIGS. 1 and 2, but is formed by two straight-line outer contour sections 47, 49 arranged at an angle to one another, of which the outer contour section 47 adjoining the reinforcement region 45 is oriented essentially parallel to the closing plane of the door 1 in the assembled state.

For example, the connecting device 7, independently of whether it is shaped according to the design in FIGS. 1, 2 or according to the design in FIGS. 3, 4, has a depth in the load direction in the range of 10 mm to 20 mm and a height measured in the web direction R in the range of 15 mm to 30 mm.

A detail of a door 1 is shown in its completely closed position in FIG. 5. The door has a stabilizing device 33 arranged on the lower edge 31 of the lower curtain segment 9, which is designed, for example, in accordance with WO 2004/088080 A1. The stabilizing device 33 stands flat on the floor 35. On the lateral edges 37 of the door leaf 5, guide devices, such as guide rollers or guide rails, can be arranged, which cooperate with associated guide elements which are arranged on the wall 39 delimiting the wall opening, which can also have a frame profile 41, for example, in order to guide and assist the closing and opening movement of the door leaf 5. The guide device-guide element arrangement 43 defines the movement path R.

Thus, the conflict of interest between a high running speed and high wind stability on the one hand and a simple repair and maintenance option on the other can be resolved by means of the roller door 1. The separation of functions between the stabilization of the curtain 3, which is created via the stabilizing device 33, and the fastening of the curtain segments 9, 11 to one another, which is carried out by the connecting device 7, plays a crucial role. If the curtain 3 is damaged, it is no longer necessary to replace the entire curtain 3. The possibility is created of separating the curtain segment 9 forming the lower edge of the curtain 3 from the curtain segment 11 trailing in the opening movement direction in a simple, cost-effective, and easy-to-assemble manner, so that one of the curtain segments 9, 11 and/or the connecting device 7 can be replaced while the other door components can remain installed.

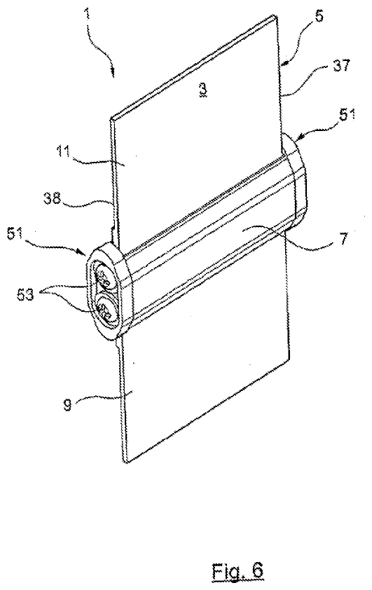

FIG. 6 shows a schematic outline sketch of a door 1, in which the connecting device 7 releasably interconnects two adjacent curtain segments 9, 11, wherein the connecting device 7 is formed in accordance with the embodiment of FIGS. 3 and 4. The mutually associated edges of the curtain segments 7, 9 are received in a formfitting manner in receptacles 13, 15 of the connecting device 7 and are releasably fastened therein. In FIG. 6, the connecting device 7 is provided at both lateral ends with a securing device 51 applied at each lateral edge 37, 38 of the curtain segments 9, 11, which are screwed to the connecting device 7 using two screws 53 each to prevent unwanted relative movement of the curtain segments 9, 11 in the direction of the intended dividing line or to prevent unwanted movement of the curtain segments 9, 11 away from one another in the direction of the intended dividing line or in the longitudinal extension direction of the connecting device 7.

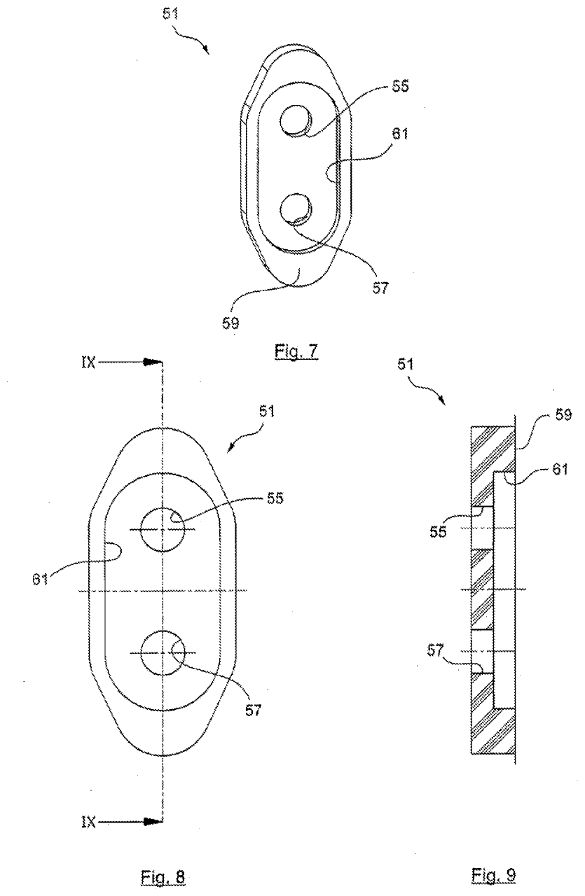

The security device 51 is shown in FIG. 7, FIG. 8, and FIG. 9, wherein FIG. 7 shows a perspective view, FIG. 8 shows a top view, and FIG. 9 shows a sectional view corresponding to section line IX-IX on FIG. 8. For example, the securing device 51 is implemented as an end or safety cap, which can be produced from plastic or metal, for example. In order that the securing cap 51 can be screwed to the connecting device 7, the securing cap 51 is provided with two through holes 55, 57 for the screws 53. The through holes 55, 57 are positioned and dimensioned so that the screws are screwed into the lower edges, in particular thickenings, of the curtain segments 9, 11. Furthermore, the securing cap 51 has a depression 61 formed on an upper side 59, so that the screws 53 are essentially countersunk within the depression 61 in the screwed state. Furthermore, the depression 61 can be dimensioned so that the connecting device 7 can be accommodated therein. An inner dimension of the depression 61 can be matched to an outer contour of the connecting device 7. The coordination can be such that the connecting device 7 is held in the depression 61 in a formfitting and/or clamping manner. Referring again to FIG. 6, it can be seen that the securing device 51 is dimensioned larger in the direction of the movement path than the connecting device 7 and protrudes in the direction of the movement path over the connecting device 7 and extends over it. As a result, the securing device 51 can be applied to the lateral edges 37, 38 of the curtain segments 9, 11.

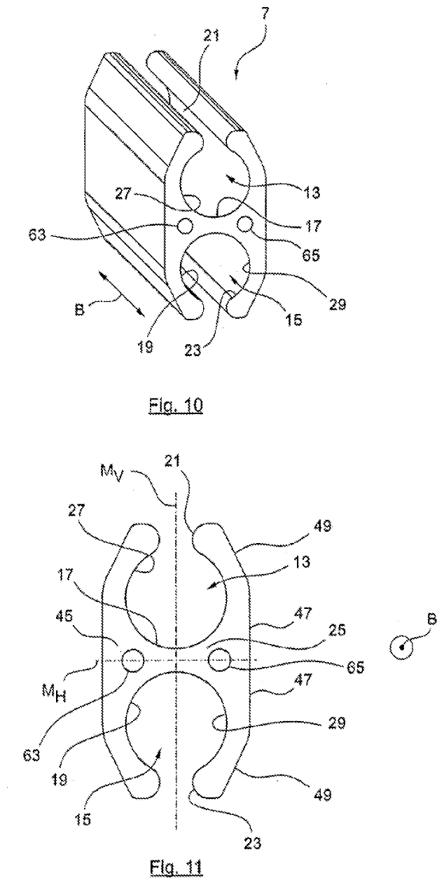

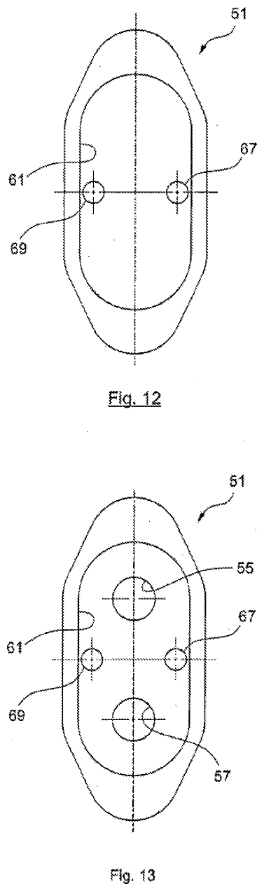

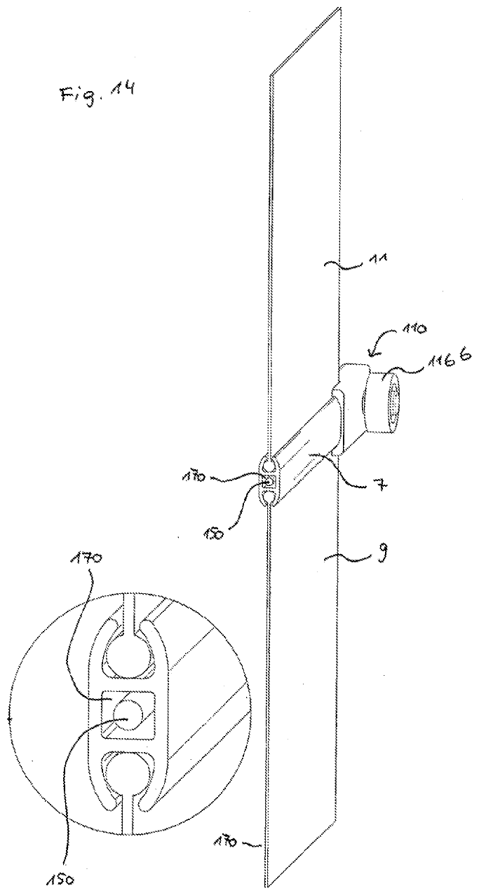

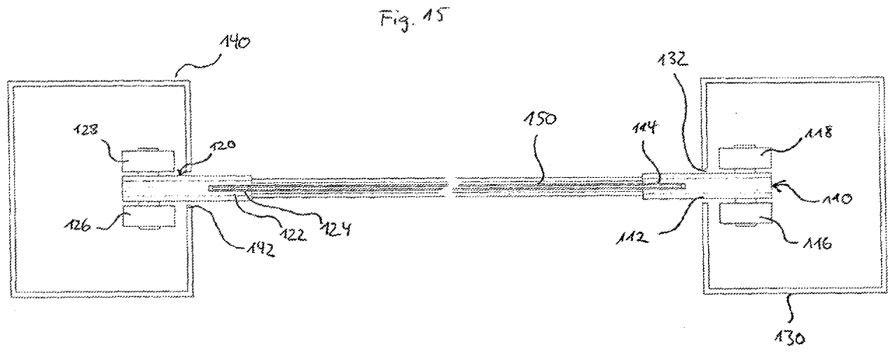

FIGS. 10, 11 show a further example embodiment of a connecting device 7, which is basically designed like the connecting device 7 from FIGS. 3 and 4 and is provided with two lateral fastening holes 63, 65 for accommodating fasteners, such as screws, clips, or the like for fastening the securing device 51 and the connecting device 7 together. The connecting device 7 can be combined with the securing device 51 according to FIGS. 7 to 9 or with the securing device 51 according to FIG. 12 or 13, which represent further example embodiments. If the connecting device 7 is combined with the securing device 51 from FIG. 12, the securing device 51 is free of direct fastening to the curtain segments 9, 11. The fastening takes place exclusively indirectly via the fastening holes 63, 65 arranged in the connecting device 7, to which two through holes 67, 69 in the securing device 51 are assigned. When combined with the securing device 51 from FIG. 13, the fastening can take place both via the through holes 67, 69 and via the central holes 55, 57.

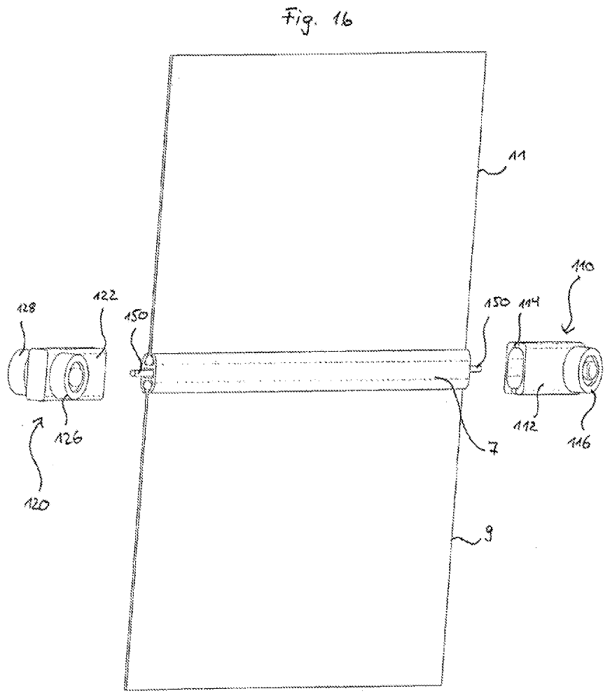

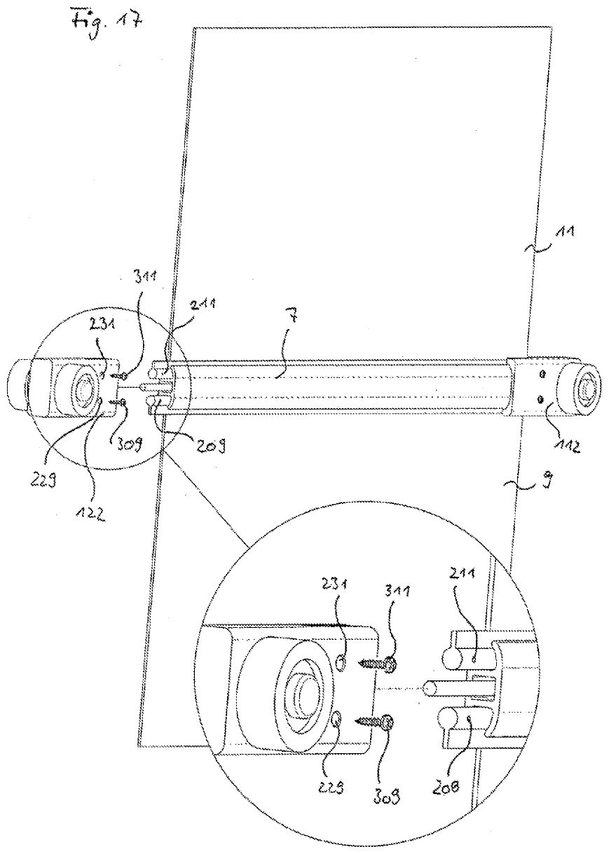

In the embodiments shown in FIG. 14, FIG. 15, and FIG. 16, securing modules 110 and 120 are placed on opposite ends of the connecting device 7. Each of these securing modules 110 and 120 comprises an end cap 112 or 122, which receives the axial end of the connecting device 7 and comprises a slot 114 or 124 penetrated by the lateral edges of the curtain segments 9 and 11. On the caps 112 and 122 of the securing modules 110 and 120, guide rollers 116, 118 and 126, 128 are rotatably mounted with respect to roller axes extending perpendicular to the closing plane in the closed position. The guide rollers 116, 118 and 126 128 are arranged on opposite sides of the curtain segments. The guide rollers 116, 118 and 126, 128 interact with guide means 130 and 140 designed as hollow profiles. These guide means are arranged in a fixed manner with respect to the wall opening and accommodate the guide rollers 116, 118 or 126, 128. The boundary walls 132, 142 of the hollow profiles 130, 140 facing toward the wall opening are penetrated by slots 132 and 142, which are penetrated by the caps 112 and 122 placed on the connecting device 7. The guide rollers 116, 118 and 126, 128 form contact surfaces which can roll on the boundary surfaces, facing away from the wall opening, of the boundary walls through which the slots 132, 142 pass. On the one hand, this enables the movement of the door leaf to be guided. On the other hand, the securing modules 110, 120, cooperating with the securing means 130 and 140, implement a securing device that absorbs axial forces acting in the direction of the connecting device 7.

In order to absorb the axial forces and to relieve the load on the connecting device 7, the securing device of the embodiment shown in FIGS. 14 to 16 is equipped with an additional tension safeguard 150, via which the caps 110 and 120 attached to opposite ends of the connecting device 7 are connected to one another. In the embodiment shown in FIGS. 14 to 16, the additional tension safeguard is designed in the form of a cable and is accommodated in a channel 170 which passes through the connecting device 7 between the receptacles 13 and 15 in the axial direction. The tension safeguard can be attached to the caps 110 and 120 in a formfitting, friction-locked, and/or materially-bonded manner. The caps 110 and 120 can be attached to the connecting device 7 in a formfitting, friction-locked, and/or materially-bonded manner.

In the embodiment shown in FIGS. 14 to 16, the outer contour of the connecting device 7 corresponds approximately to the outer contour of the connecting device according to FIGS. 3 and 4. In other embodiments, the securing device can also be embodied in conjunction with connecting devices according to FIGS. 1 and 2, however. In this case, the tension safeguard can have two cable-shaped or strand-shaped elements, which can be arranged on both sides of the plane of symmetry M_{V} and within the plane of symmetry M_{H}. The caps of the securing device can also be pressed onto the connecting device. In addition, they can be adhesively bonded and/or screwed on.

The door shown in FIG. 17 may differ from the doors explained with reference to FIGS. 14 to 16 in that the edges of the curtain segments 9 and 11 to be connected to one another extend in the axial direction beyond the connecting device 7 and are penetrated by holes 209, 211. The edges of the curtain segments that extend beyond the connecting device 7 are formed in the embodiment shown in FIG. 17 by connecting means, which are received in the assembled state in the end caps 112, 122 of the securing modules 110, 120. The end caps are penetrated at locations corresponding to the holes 209, 211 by holes 229, 231, which in the assembled state are aligned with the holes 209, 211 and are used to receive fixing bolts 309, 311 designed as fixing screws, which can fix the edges extending perpendicular to the path of movement of the curtain segments 9, 11 with respect to the end caps and the connecting device 7.

The features disclosed in the above description, the drawings, and/or the claims can be important both individually and in any combination for the implementation of embodiments of the present disclosure.

### LIST OF REFERENCE SIGNS

1 door
3 curtain
5 door leaf
7 connecting device
9, 11 curtain segment
13, 15 receptacle
17, 19 guide groove
21, 23 longitudinal opening
25 connecting web
27, 29 insertion opening
31 lower edge
33 stabilizing device
35 floor
37, 38 lateral edge
39 wall
41 frame profile
43 guide arrangement
45 reinforcement region
47, 49 outer contour section
51 safeguard
53 screw
55, 57 hole
59 upper side
61 depression
63, 65 fastening hole
67, 69 through hole
110, 120 securing modules
114, 124 slot
112, 122 end caps
116, 118, 126, 128 guide rollers
130, 140 hollow profiles
132, 142 boundary walls
150 tension safeguard
170 channel
209, 211, 229, 231 holes
309, 311 fixing bolts
B width direction
M_{V} vertical center axis
M_{H} horizontal center axis
R movement path

1-23. (canceled)

24. A roller door assembly comprising:
a door leaf that is at least partially configured as a web-like curtain made of flexible material and which is movable along a movement path between an open position, in which the door leaf at least partially opens a wall opening and forms a multi-layer winding above the wall opening, and a closed position, in which the door leaf at least partially closes the wall opening; and
a stabilizing device coupled with the web-like curtain, wherein the stabilizing device extends approximately perpendicularly to the movement path, and wherein the stabilizing device is configured to, when the door leaf is in the closed position, counteract deformation of the curtain in a load direction that extends perpendicularly to a closing plane that is defined by the movement path and the stabilizing device;
wherein the web-like curtain includes at least a first curtain segment and a second curtain segment that follow one another in the direction of the movement path, and wherein the at least first and second curtain segments are releasably connected to one another along at least one predetermined separating line or at least one predetermined separating region in such a way that mutually facing edges of the first and second curtain segments that extend perpendicularly to the moving direction remain deformable; and
wherein the at least one predetermined separating line or the at least one predetermined separating region extend approximately perpendicularly to the closing plane.

25. The roller door assembly of claim 24, further comprising an at least partially elastically deformable connecting device configured to releasably connect the mutually facing edges of the first and second curtain segments.

26. The roller door assembly of claim 25, wherein the connecting device includes a first receptacle connected with the first curtain segment and a second receptacle connected with the second curtain segment, wherein the first and second receptacles are configured to provide formfitting accommodation of respective ones of the mutually facing edges of the first and second curtain segments, and wherein the mutually facing edges have thickenings formed as beads or beadings.

27. The roller door assembly of claim 26, wherein:
the first and second receptacles are produced in one piece with each other;
respective ones of the first and second receptacles have a guide groove that extends in a longitudinal direction of the receptacles;
the respective guide grooves have a constant cross section in the direction of the predetermined separating line;
the guide grooves are configured to allow insertion of respective ones of the mutually facing edges in the longitudinal direction;
respective ones of the receptacles further include respective longitudinal openings that are oriented in the direction of the movement path; and
the longitudinal openings have a width in the load direction that is smaller than a maximum dimension of the thickenings.

28. The roller door assembly of claim 27, wherein a cross section of the connecting device in a section plane that perpendicularly to the longitudinal direction is designed symmetrically with respect to an axis oriented in the direction of the movement path or with respect to an axis oriented parallel to the predetermined separating line, wherein the axis extends through a connecting web that connects the first and second receptacles.

29. The roller door assembly of claim 25, wherein the connecting device is configured to release at least one of the curtain segments when a load acting on the web-like curtain exceeds a predetermined load limit in the load direction.

30. The roller door assembly of claim 25, wherein the closed position is a position in which the connecting device is at a distance in the range of 250 millimeters (mm) to 1250 mm from a floor related to the wall opening.

31. The roller door assembly of claim 25, wherein the connecting device is a double beading rail.

32. The roller door assembly of claim 25, wherein a restoring force that counteracts a deformation of the connecting device in the load direction is smaller than a restoring force that counteracts a deformation of the stabilizing device in the load direction.

33. The roller door assembly of claim 25, further comprising a safeguard configured to release the first and second curtain segments from one another, and further comprising a securing device that is configured to prevent relative movement of the first and second curtain segments along the predetermined separating line.

34. The roller door assembly of claim 33, wherein the securing device is connected in a formfitting manner to the connecting device.

35. The roller door assembly of claim 33, wherein the securing device is configured to absorb axial forces acting parallel to the edges of the first and second curtain segments that extend perpendicularly to the movement path.

36. The roller door assembly of claim 35, wherein the securing device includes:
securing means that are fixedly attached with respect to the wall opening; and
at least one securing module attached to the connecting device, wherein the securing module includes at least one contact surface that can be applied to a counter surface of the securing means for absorbing the axial forces.

37. The roller door assembly of claim 36, wherein the contact surface is formed by at least one guide roller that is rotatably mounted with respect to a roller axis that extends perpendicularly to the closing plane in the closed position, and when the roller door is in the closed position, the at least one guide roller is accommodated in the securing means, wherein the securing means extends approximately in a direction of gravity, and wherein the securing means includes a slot that is passed through by a lateral edge of the door leaf and is designed as a hollow profile.

38. The roller door assembly of claim 36, wherein at least one fixing bolt or fixing screw passes through the at least one securing module.

39. The roller door assembly of claim 33, wherein the securing device has at least two safety modules that are attached to opposite axial ends of the connecting device in a formfitting, frictional, or materially-bonded manner.

40. The roller door assembly of claim 39, wherein the securing device has a pull safety that connects the at least two safety modules to one another.

41. The roller door assembly of claim 40, wherein the pull safety passes through a channel in the connecting device, wherein the channel extends parallel to the edges of the first and second curtain segments that extend perpendicularly to the movement path.

42. The roller door assembly of claim 25, further comprising at least one fixing device configured to fix at least one edge of at least the first or second curtain segments, wherein the at least one edge extends perpendicularly to the movement path.

43. The roller door assembly of claim 42, wherein the fixing device includes at least one fixing bolt or fixing screw that passes through the at least one edge and extends approximately perpendicularly to the closing plane.

44. The roller door assembly of claim 24, wherein the web-like curtain further includes a third curtain segment and a fourth curtain segment, wherein the third and fourth curtain segments follow one another in the direction of the movement path, and wherein the third and fourth curtain segments are adhesively bonded or welded to one another.

45. The roller door assembly of claim 24, further comprising:
at least one guide device arranged on a lateral edge of the door leaf, wherein the at least one guide device is configured to guide the door leaf when the door leaf is moving in the closing plane; and
an inlet arrangement arranged at an upper edge of the guide device, wherein the inlet arrangement is configured to allow a lateral edge of the door leaf to be automatically insertable into the guide device during a closing movement of the roller door assembly.

46. The roller door assembly of claim 24, wherein one of the first and second curtain segments forms a lower edge of the web-like curtain, and wherein the one of the first and second curtain segments that forms a lower edge of the curtain has an optical indicator that is visually different from the other one of the first and second curtain segments.
